(19) United States
(12) Patent Application Publication
(10) Pub. No.: US 2022/0118569 A1
(43) Pub. Date: Apr. 21, 2022

(54) An electrospindle

(71) Applicant: Saccardo Elettromeccanica S.r.l., Santorso (VI) (IT)

(72) Inventor: Francesca Saccardo, Santorso (VI) (IT)

(21) Appl. No.: 17/423,827

(22) PCT Filed: Apr. 29, 2019
(86) PCT No.: PCT/IB2019/053480

§ 371 Date: Jul. 16, 2021

(30) Foreign Application Priority Data
Jan. 23, 2019 (IT) 102019000001027

(51) Int. Cl. B23Q 3/12; B24B 23/02; B24B 45/00; B27B 5/32

(52) U.S. Cl. CPC B23Q 3/12; B27B 5/32; B24B 45/006; B24B 23/022

(57) ABSTRACT

An electrospindle includes a motor for moving a tool and a motor shaft for transmitting motion from the motor to the tool. The electrospindle has a gripping head of the tool and a coupling of the tool to the motor shaft, and the gripping head includes two flanges, between which a portion of the tool and at least one thrust nut of a first flange can be interposed toward a counterflange, so as to hold the tool in position. The electrospindle further includes an insert coupled by screwing to the free end of the motor shaft, the thrust nut being coupled on an end portion of the insert.

### FIELD OF APPLICATION

The present invention is applicable to the field of industrial machining operations and, in particular, concerns machine tools.

More in detail, the present invention relates to an electrospindle for industrial machining operations.

### BACKGROUND ART

It is known that material machining operations in the industrial field now take place almost exclusively by electric tools. Operations such as cutting, bending, milling, drilling or other, in fact, typically take place by means of special machines equipped with the appropriate tools to perform the machining.

Among these machines, there are numerous cases in which they comprise electrospindles, i.e. mechanical devices on which a self-centering device can be mounted which allows a tool to be dragged in rotation in order to be able to perform a certain type of machining with it.

This tool is typically held in position by the head of the electrospindle. The latter is associated with the free end of the motor shaft of the electrospindle and comprises two flanges which hold the tool necessary for machining between them. More in detail, a flange is integral with the motor shaft, while a counterflange is pushed against the flange by a nut screwed to the free end of the motor shaft.

Moreover, in some variants, the free end of the motor shaft also has a threaded blind hole which extends along the longitudinal development axis of the shaft and which receives, by screwing, a second tool.

This configuration, although useful and functional, has some drawbacks.

First of all, the blind hole for receiving the second tool is exposed to dirt and damage when it is not used and this often forces the replacement of the entire motor shaft.

In general, moreover, the entire head of the electrospindle is subjected to considerable stresses and such as to expose to the risk of damaging the free end of the motor shaft. Moreover, typically this free end protrudes from the head, subjecting it to further risk of damage. In all such cases it is necessary to replace the shaft.

Given the stresses to which it is subjected, the motor shaft is generally made of high-quality material so its replacement is expensive. Moreover, with regard to the damage to its free end, typically it would be sufficient to harden it, but the machining operation to which it should be subjected would render it unusable as a motor shaft.

It is also known that the motors have their own sense of rotation (right-handed or left-handed). The threads of the nut and of the free end of the motor shaft, as well as those of the blind hole and of the additional tool, must be in accordance with these directions of rotation, resulting in the presence of different motor shafts, i.e. one for each combination of rotation of motor and tools. The user who wants to be able to use any of these combinations should therefore have different motor shafts and replace them with one another according to the machining need.

### PRESENTATION OF THE INVENTION

The object of the present invention is to overcome at least partially the drawbacks described above by providing an electrospindle in which the motor shaft is more protected in order to limit its replacement.

In particular, an object of the present invention is to provide an electrospindle in which the free end of the motor shaft is protected from dirt and violent stresses.

Another object is to provide an electrospindle which does not require the replacement of the motor shaft when the rotation direction of the motor varies.

These objects, as well as others which will be better understood below, are achieved by an electrospindle according to one or more of the following claims, which are an integral part of the present invention.

In particular, the electrospindle comprises a motor for moving a tool and a motor shaft for transmitting motion from the motor to the tool. It also includes a gripping head of the tool, also for coupling the latter to the motor shaft. In this sense, the head in turn comprises two flanges between which a portion of the tool and at least one thrust nut of a first flange towards the counterflange can be interposed so as to hold the tool in position.

According to an aspect of the invention, the electric tool also comprises an insert coupled by screwing to the free end of the motor shaft, the thrust nut being coupled on at least one end portion of the insert.

Advantageously, therefore, the insert in the substance functionally replaces the motor shaft in its functional terminal part. In other words, the terminal exposed part is no longer constituted by the free end of the motor shaft, but by the insert. The component exposed to damage and dirt is therefore advantageously the insert and not the motor shaft.

Still advantageously, therefore, in the event of damage or deterioration, the replacement of the insert is easier and less expensive not only in terms of operation time and downtime, but also in terms of materials.

Still advantageously, the insert can be made of the most suitable material for its exposed positioning. In particular, it can be made with a less expensive material than the motor shaft and suitably hardened.

Its coupling by screwing to the motor shaft allows to obtain an advantageously stable but low-cost coupling.

As stated, the prior art provides for the presence of different motor shafts in accordance with the combinations of the rotation directions of the motor and of the tools. On the contrary, the present invention allows to use a single motor shaft and to provide different inserts in accordance with the aforementioned rotation directions. Advantageously, therefore, the replacement of an insert with another suitable for the new rotation combination is certainly faster and simpler. Moreover, still advantageously, also the operation costs are decreased.

### BRIEF DESCRIPTION OF THE DRAWINGS

Further features and advantages of the invention will be more evident in light of the detailed description of some of the preferred but not exclusive embodiments of an electrospindle according to the invention, illustrated by way of non-limiting example with the aid of the accompanying drawing tables, wherein:

FIG. 1 represents a portion of an electrospindle according to the invention in a sectional view;

FIG. 2 represents a detail of an electrospindle according to the invention in a perspective view.

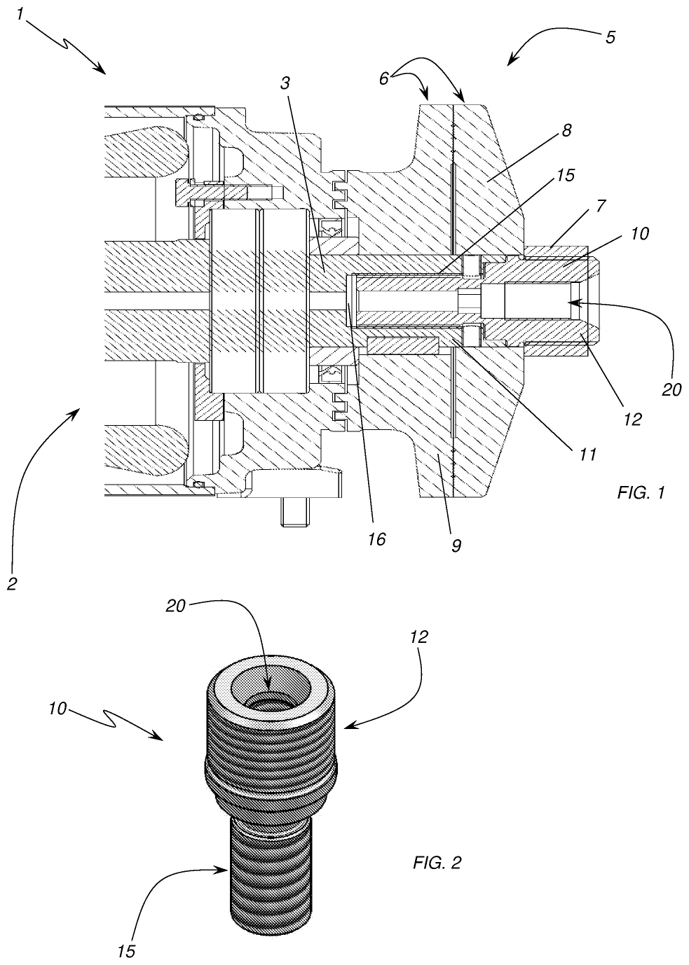

### DETAILED DESCRIPTION OF SOME PREFERRED EXEMPLARY EMBODIMENTS

With reference to the mentioned figures, described herein is an electrospindle 1 commonly used for machining operations such as cutting, milling, drilling or other.

By definition, an electrospindle 1 comprises a motor 2 for moving a tool, the latter not represented in the figures, and a motor shaft 3 for transmitting motion from the motor 2 to the tool.

The power of the motor 2 is typically adequate for the use to which the electrospindle 1 is directed and, consequently, also the embodiment of the motor shaft 3 is consequent to the efforts that it must bear. In this sense, the motor shaft 3 is typically made of noble materials and with appropriate machining operations that do not reduce its mechanical seal.

According to an aspect of the invention, the electrospindle 1 comprises a gripping head 5 of the tool. Moreover, this head 5 not only retains the tool, but realizes the coupling between the latter and the motor shaft 3.

In particular, the head 5 comprises two flanges 6 between which a portion of the tool can be interposed. There is also a thrust nut 7 which has the function of pushing a first flange 8 towards the counterflange 9 so as to hold the tool between them.

According to another aspect of the invention, the electrospindle 1 also comprises an insert 10 coupled by screwing to the free end 11 of the motor shaft 3.

Typically, the counterflange 9 of the head 5 is integral with the motor shaft 3, but this detail must not be considered as limiting for the invention.

With respect to the thrust nut 7, on the other hand, it is coupled to an end portion 12 of the insert 10.

Advantageously, therefore, the free end 11 of the motor shaft 3 is no longer protruding from the head 5, as instead occurs in the known art, but the insert 10 is protruding.

Since the thrust nut 7 is screwed onto the insert 10, in substance, still advantageously, the latter functionally replaces the motor shaft 3, cooperating in retaining the tool.

Still advantageously, in the event of damage or deterioration, the replacement of the insert 10 is easier and less expensive not only in terms of time for performing such a replacement and of downtime, but also in terms of materials used to make such piece.

Still advantageously, in fact, the insert 10 can be made of the most suitable material for its exposed positioning. In particular, it can be made with a less expensive material than the motor shaft 3 and suitably hardened.

Its coupling by screwing to the motor shaft 3 also allows to obtain an advantageously stable but low-cost coupling.

More in detail, the insert 10 comprises a first threaded end 15 while the free end 11 of the motor shaft 3 comprises a first hole 16 typically but not necessarily blind extending along the longitudinal development axis of the motor shaft 3 and which is counter-shaped on the first end 15 of the insert 10. Moreover, this first hole 16 is threaded to receive this first end 15 of the insert 10 by screwing.

As stated before, the prior art provides for the operation of different motor shafts 3 in accordance with the combinations of the rotation directions of the motor 2 and of the tools. On the contrary, the present invention advantageously allows to use a single motor shaft 3 and to provide different inserts 10 in accordance with the aforementioned rotation directions. Still advantageously, therefore, the replacement of an insert 10 with another suitable to the new rotation combination is certainly faster and simpler than having to replace the motor shaft 3.

According to another aspect of the invention, the end portion 12 of the insert 10 is also threaded so as to receive the thrust nut 7 by screwing.

Advantageously, as mentioned, any damage to the thread will only require the replacement of the insert 10 and not of the whole motor shaft 3.

According to a further aspect of the invention, this thread is double comprising a first right-handed thread and a second left-handed thread.

Advantageously, therefore, both right-handed and left-handed thrust nuts 7 can be screwed onto the same end portion 12 of the insert 10. In other words, the insert 10 can be used indifferently with right-handed or left-handed tools. This limits, still advantageously, not only the number of components to be provided in the production of the electrospindle 1 of the invention, but also the number of times in which it is necessary to replace the insert 10 itself.

In order to ensure the tightness of the thrust nut 7, according to an embodiment variant not shown in the figures, the electrospindle comprises two nuts: a first nut with a thread suitable for coupling with the first thread of the end portion of the insert, and a second nut with a thread suitable for coupling with the second thread.

In this way, whatever the direction of rotation imposed by the motor, the tool is correctly held in position since at least one of the first and second nuts will not be urged to unscrew.

Still advantageously, the same tool can be used with both rotation directions, thus speeding up machining and reducing machine downtime.

According to the embodiment which is described, the first nut and the second nut comprise mutual coupling means, but this detail must not be considered limiting for further different embodiment variants.

According to another aspect of the invention, the end portion 12 of the insert 10 also comprises a second hole 20 which is also typically but not necessarily blind, which extends along the longitudinal development axis of the insert 10 itself to receive and retain an additional tool.

This second hole 20 is typically threaded to retain the additional tool by screwing. In the industry jargon, this second tool connection is typically referred to as “half throttle”.

An embodiment variant was described just before in which the end portion of the insert has a double thread to ensure the use of both right-handed tools and left-handed tools. In this situation, it is clear that it is preferable that the thread of the second hole is also advantageously double, comprising a third right-handed thread and a fourth left-handed thread so as to be able to screw additional right-handed and left-handed tools.

Advantageously, therefore, with this arrangement, the number of inserts necessary for carrying out different machining operations by means of the electrospindle of the invention is even more reduced. Still advantageously, the causes of replacement of the insert and, therefore, machine downtime, are reduced.

In light of the above, it is therefore understood that the electrospindle of the invention overcomes the drawbacks noted in the prior art.

In particular, the motor shaft is certainly better protected since it does not protrude in any way from the head that holds the tool. In this sense it is protected not only from inappropriate stress and damage, but also from dirt.

On closer inspection, the solution proposed in the present patent application does not even require the replacement of the motor shaft when the combination of the rotation direction of the tool and/or of the motor changes.

Although the invention has been described with particular reference to the accompanying figures, the reference numerals used in the description and claims are used to improve the intelligence of the invention and do not constitute any limitation to the claimed scope of protection.

The invention claimed is:

1. An electrospindle comprising:
a motor for moving a tool;
a motor shaft for transmitting motion from said motor to the tool;
a gripping head adapted to engage the tool and couple the tool to said motor shaft,
said head comprising at least two flanges, between which a portion of the tool is gripped, and at least one thrust nut that pushes a first flange of said two flanges towards a counterflange of said two flanges so as to hold the tool in position; and
an insert coupled by screwing to a free end of said motor shaft, said at least one thrust nut being coupled to at least one end portion of said insert.

2. The electrospindle according to claim 1, wherein said insert comprises a first threaded end and said free end of said motor shaft comprises a first hole, which develops according to a longitudinal development axis of said motor shaft, said first hole being shaped on said first threaded end of said insert and being threaded to receive said first end of said insert by screwing.

3. The electrospindle according to claim 2, wherein said end portion of said insert is threaded so as to receive said at least one thrust nut by screwing.

4. The electrospindle according to claim 3, wherein a thread of said end portion of said insert is double by comprising a first right-handed thread and a second left-handed thread.

5. The electrospindle according to claim 4, wherein said at least one thrust nut comprises a first nut with a thread suitable for coupling with said first thread of said end portion of said insert and a second nut with a thread suitable for coupling with said second thread of said end portion of said insert.

6. The electrospindle according to claim 5, wherein said first nut and second nut comprise mutual coupling means.

7. The electrospindle according to claim 3, wherein said end portion of said insert comprises a second hole, which extends along the longitudinal development axis of said insert to receive and hold an additional tool.

8. The electrospindle according to claim 7, wherein said second hole is threaded to retain said additional tool by screwing.

9. The electrospindle according to claim 8, wherein a threading of said second hole is double by comprising a third right-handed thread and a fourth left-handed thread.
